(19) United States
(12) Patent Application Publication
(10) Pub. No.: US 2006/0099870 A1
(43) Pub. Date: May 11, 2006

(54) Fiber mat bound with a formaldehyde free binder, asphalt coated mat and method

(76) Inventors: Ruben Gregory Garcia, Littleton, CO (US); Alan Michael Jaffee, Bowling Green, OH (US); Philippe Marie Scheerlinck, Lakewood, CO (US); Lance Wang, Parker, CO (US)

Correspondence Address: Robert D. Touslee;Johns Manville, 10100 West Ute Avenue, Littleton, CO, 80127, US

(21) Appl. No.: 10/983,871

(22) Filed: Nov. 8, 2004

(51) Int. Cl. D04H 13/00; B32B 5/18

(52) U.S. Cl. 442/374; 442/327; 442/355

(57) ABSTRACT

Fibrous, nonwoven mats are disclosed that are bound with a formaldehyde-free, heat resistant resin in direct contact with the fibers. The heat resistant resin is capable of withstanding coating with a hot, molten material like asphalt or a mixture containing asphalt having a temperature of at least about 300 degrees F. and up to 450 degrees F. or higher. The preferred heat resistant resins are epoxies and urethanes, or mixtures thereof. The methods of making these mats with wet processes are also disclosed.

The present invention includes a wet laid glass fiber mat bound together with formaldehyde free and heat resistant binder, a method of making the mat the mat and the mat coated with asphalt. The mat is useful in a wide range of products including roofing products, carpet tiles and sound deadening products.

### BACKGROUND

Urea formaldehyde (UF) and/or melamine formaldehyde (MF) are commonly used as resin binders to bond glass fibers together to form nonwoven mats. Certain conditions, including elevated temperature, and high humidity, can cause release of formaldehyde vapor into the environment due to hydrolysis of the binders. This has caused concern to at least some users of the mat, particularly if it occurs in the customers process and if the products are intended for use on the inside of buildings or residences. Low free formaldehyde binders have been developed and used for some time, but the presence of formaldehyde in the binder still is a concern. Other binders such as those based on acrylic resins have been utilized in lieu of UF or MF binders in the search for a formaldehyde-free alternative in binding of non-woven mats, but often these binders do not have the heat resistance properties necessary for coating with hot asphalt (375-450 deg. F.).

U.S. Pat. No. 4,327,143 to Alvino et al. discloses moisture resistant laminates impregnated with an impregnating composition comprising epoxy resin and a dicyandiamide derivative. Disclosed is an epoxy cured glass fiber multilayer board suitable for printed circuit boards. It is a different type of product and is not coated with asphalt.

U.S. Pat. No. 5,273,816 to Olson et al. discloses a laminate board possessing improved dimensional stability having applications in printed circuit boards. A woven glass or aramid fiber mat is coated with bisphenol-A type epoxy resin, brought to B stage, and cured. Particularly, the laminated board is prepared by impregnating a reinforcing substrate (i.e. glass fibers and aramid fibers) with an epoxy resin having a molecular weight above 850 g/mol. The epoxy resin is a bisphenol-A type resin. The disclosed laminate board is not coated with hot asphalt and is not formed by solely using glass fiber mats that are wet laid.

U.S. Pat. No. 5,614,126 to Gruber et al. discloses a solvent-less curable resin composition having particular applications in the fabrication of prepregs. Fibrous material is bonded by UV curable solids, or a mixture of liquid and solid epoxy composition, with an initiator sensitive to UV radiation. The fibrous material is not indicated to be a glass fiber. More specifically, the prepreg is UV cured at a later time. The prepreg is not intended to be coated with asphalt and the solid epoxy composition is not delivered via an aqueous system.

U.S. Pat. No. 5,883,021 to Beer et al. discloses a glass monofilament and strand mats, vacuum-molded thermoset composites reinforced with the same and methods for making the same. The glass monofilament fiber bundles are mixed with a thermoset resin and vacuum molded to form a rigid mat. The thermosetting matrix material comprises a thermosetting film forming material selected from the group consisting of polyesters, vinyl esters, epoxides, phenolics, aminoplasts, polyurethanes, and derivatives and mixtures thereof. The mat is not aqueous laid utilizing an aqueous epoxy resin system as a binder.

U.S. Pat. No. 6,140,259 to Ushida et al. discloses laminate, glass fiber non-woven fabric therefore and a method of producing glass fiber non-woven fabric using glass fiber mats bonded by a special epoxy composition. This special epoxy composition has a glass transition temperature higher than 120° C. so that the laminated boards produced do not contract. Such laminated boards are likely printed circuit boards. They are free from porosity and are not coated with asphalt. The resin and the glass fibers are not laid using an aqueous system. Such laminated boards do not have applications as asphalt coated roofing products.

U.S. Pat. No. 6,265,330 to Pennington et al. discloses non-Asbestos insulation for rocket motor casings. The insulation comprises a glass fiber blanket bonded by phenolic resin and a Buna-N rubber, which is an acrylonitrile-butadiene-acrylic acid terpolymer. Such insulation blanket is not a formaldehyde-free glass fiber mat and also phenolic resin is phenyl formaldehyde.

U.S. Pat. No. 6,372,675 to Diehl discloses a nonwoven fabric of chemically bonded non-cellulose fibers, polymer fibers and graphite fibers having improved wet tensile strength. The fabric includes a random arrangement of non-cellulose fibers and an essentially formaldehyde free latex binder. The latex binder contains ≧6.7 weight % of vinyl cyanide monomer to bond the non-cellulose fibers and form a nonwoven fabric. The binder is not reported as being capable of resisting hot asphalt in an asphalt coating process.

U.S. Pat. No. 6,586,353 to Kiik et al. discloses a roofing underlayment comprising a fiberglass substrate containing a felt saturated with asphalt, fly ash, calcium carbonate, ceramic microspheres, and a binder of acrylic latex. The acrylic latex is a low temperature binder incapable of surviving a hot asphalt coating process.

Foreign Patent No. JP 11-012946 to Togawa et al. discloses a water-based resin composition for making a nonwoven fabric that has utility as an asphalt roofing sheet. The binder is an organic adhesive including polyvinyl alcohol, modified cellulose and polyurethane resin.

Wet laid fibrous mats in which a cured formaldehyde containing binder, or a cured, non-heat resistant binder, is in direct contact with the fibers in the mat and which are later impregnated or coated with a formaldehyde-free, heat resistant binder are quite different than and not the same as a nonwoven, fibrous mat having a formaldehyde free, heat resistant binder in direct contact with the bare or sized fibers.

Although many advances have been made in the field of aqueous polymer bonded glass fiber mats for reinforcing products made by coating or saturating the mat with molten asphalt, there remains a need in the art for a formaldehyde-free resin bonded, fibers held together in the mat with the resin in direct contact with the glass fibers, mat that can withstand the high temperatures required for molten asphalt impregnation during the manufacture of asphalt building products and that can be made in the wet forming or wet laid processes used to manufacture more than a billion pounds of such mat each year. It is important that the binder can be applied in an aqueous solution, emulsion or suspension on-line, on the wet forming machine, to a wet web of fibers because having to do otherwise would require millions of dollars of new or additional investment.

### SUMMARY OF THE INVENTION

The present invention includes a formaldehyde free, nonwoven, fiberglass, wet laid, mat comprised of glass fibers and a formaldehyde-free binder in direct contact with the fibers, or sized fibers, holding the fibers together in the mat, the binder comprising any formaldehyde-free binder that provides a tensile strength in the dry mat of at least about 70 lbs./3 inch width at room temperature, when having an LOI in the range of about 5 to about 30 wt. percent and that provides sufficient hot strength to perform satisfactorily in a hot molten material, like asphalt, having a temperature of at least about 300 deg. F. and up to at least about 450 deg. F.

Exemplary binders useful in the present invention contain one or more resins or resin precursors in an aqueous solution, emulsion or suspension, and can include a one-component epoxy, a two-component epoxy composition or two-component urethane. The epoxy and urethane containing binders can also contain up to about 20 wt. percent, based on the amount of epoxy and/or urethane resin, of a plasticizer or modifier such as an acrylic resin. The binder can also be a polyacrylic acid resin modified with up to about 20 wt. percent of an epoxy resin and/or a urethane resin to increase the heat resistance of the polyacrylic acid resin. Any formaldehyde-free binder that provides a tensile strength in the dry mat of at least about 70 lbs./3 inch width at room temperature, when having an LOI in the range of about 5 to about 30 wt. percent and that provides sufficient hot strength to perform satisfactorily in a hot molten material, like asphalt (up to about 450 deg. F.) coating process is suitable for the invention. The polyacrylic acid resin is a homopolymer or copolymer of polyacrylic acid. Preferably, the average molecular weight of the polyacrylic acid polymer is less than 10,000, more preferably less than 5,000, and most preferably about 3,000 or less, with about 2000 being preferred. Use of a low molecular weight polyacrylic acid polymer in a low-pH binder composition can result in a final product that exhibits excellent structural recovery and rigidity characteristics. The binder composition can also include at least one additional polycarboxy polymer such as, for example, a polycarboxy polymer disclosed in U.S. Pat. No. 6,331,350, the entire contents of which are incorporated by reference herein. By “formaldehyde free” is meant that no significant amount of formaldehyde is released into the environment when the mat of the invention is subjected to temperatures of at least about 250 deg. F. and up to about 450 deg. F. In this invention, “formaldehyde free mats” are achieved by using a binder system that contains no formaldehyde component, or that contains a fortified formaldehyde component, one that is so tied up that no formaldehyde is released when subjected up to about 450 deg. F.

When stated herein that the binder or resultant resin bond is in direct contact with the fiber(s), it is meant that the formaldehyde free resin bond is in direct contact with bare fibers, or with a size coating on the bare fiber, without a coating of another resin in between. This excludes a mat bound with a formaldehyde containing resin or thermoplastic resin and later overcoated, or impregnated with a heat resistant, formaldehyde free, resin such as epoxy or urethane resin.

By size coating is meant a coating put onto the fibers by the fiber manufacturer to protect the fibers and to enhance the bond between the fibers and the bonding resin applied later as is well known. Most, if not all, glass fiber products on the market are sized and usually sold wet, the sizing being an aqueous mixture of water, usually one or more silanes and one or more lubricants and sometimes one or more dispersants and sometimes one or more film formers. Many sizing compositions for fiber for wet forming into a mat are known in the art and many sized fibers for this use are available from the fiber manufacturers. The sizing composition is not essential to the present invention as bare fibers can be used as well as most, if not all, sized fibers suitable for wet forming.

Exemplary formaldehyde-free binders include a two-component epoxy resins, urethane resins and mixtures thereof. When cross-linking agents or initiators are used, the resin and the cross-linking agent, or initiator are intimately mixed in proper proportion, so that the fine particles react to provide strong bonds between the glass fibers. The resin composition should be selected so that the binder does not undergo significant cross-linking and curing in the aqueous medium. The cross-linking agent or initiator is normally heat activating so that any significant reaction does not take place until elevated temperatures are reached in the drying and curing oven.

Epoxy binders useful in the invention may include minor additions of urethane or acrylics or in amounts approaching up to 20% and typically up to about 10 wt. percent. Both the epoxy and the urethane based polymeric resins used in the invention have high temperature resistance, i.e. able to maintain a good bond between the fibers in the mat allowing the mat to withstand asphalt impregnation temperatures of 375 to 450° F. in asphalt shingle making processes. These binders can contain up to about 20 wt. percent of an acrylic resin modifier and the epoxy binders can contain up to about 20 wt. percent of a urethane as a modifier or plasticizer. The urethane and epoxy binders of the invention can also include polyacrylic acid amine thermoset resin and/or polyvinyl alcohol PVOH resin. These latter two types of resins do not alone have sufficient heat resistance to withstand hot asphalt, but binders containing urethane and/or epoxy resins and a minor portion of PVOH and/or polyacrylic acid amine resins will have sufficient heat resistance.

Advantages of the mat of the invention include lack of a formaldehyde component, or such a component that will release formaldehyde in the temperature range of the molten asphalt. The mat of the invention can have a lower binder content and a higher fiber, glass fiber for example, content. An additional advantage of the invention is that a lower binder content, such as less than 15 wt. percent, about 14 wt. percent and down to about 5 wt. percent, can be used to make roofing mats, heretofore not practical with binders now used in roofing mats. This makes the mat more flame resistant than conventional mats used in roofing products. Suitable binder contents for the mat are in the range of about 5 to about 30 wt. percent and typically are in the range of about 5 to about 22 wt. percent, based on the weight of the dry mat. Normally the binder content will be in the range of about 10 to about 20 wt. percent, but can be in the range of about 5 to less than 15 wt. percent such as about 14 wt. percent and normally from about 8 to about 14 wt. percent for the best flame resistance.

Also included in the invention is the process of manufacturing the above described formaldehyde-free, fiberglass nonwoven, wet laid mats of the invention comprising the steps of dispersing glass fibers in an aqueous medium to disperse the fibers, forming a wet laid web by applying the aqueous fiber dispersion onto a moving, water permeable belt, applying the above described aqueous, formaldehyde-free heat resistant resinous binder onto the wet web, adjusting the binder content to the desired amount, and heating the wet, binder containing web to dry the web and cure the binder resulting in a nonwoven, heat resistant fibrous mat. Wet laid forming processes useful in the present invention are disclosed in U.S. Pat. Nos. 4,129,674, 4,112,174, 4,681,802, 4,810,576, 5,484,653, 6,043,169, 6,187, 697 and 6,548,155, the disclosures of each being hereby incorporated herein by reference.

The heat resistant, nonwoven fiberglass mats described above can then be impregnated or coated with hot, molten asphalt or hot, molten mixtures containing asphalt, at temperatures ranging from above 250 deg. F., usually above 300 deg. F., and more usually from about 375 to about 450° F. or higher in known roofing product processes to form various products including building products such as roofing shingles, other roofing products including roll roofing, sound insulation products and waterproofing products. This, and the resultant asphalt coated or asphalt saturated mats are also a part of the invention. The mats of the invention can also be used in a wide variety of other products such as carpet tile, insulation products, etc. for dimensional stability and reinforcement.

When the word “about” is used herein it is meant that the amount or condition it modifies can vary some beyond that so long as the advantages of the invention are realized. Practically, there is rarely the time or resources available to very precisely determine the limits of all the parameters of ones invention because to do would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors disclosure and understanding the inventive concept and embodiments disclosed including the best mode known to the inventor, the inventor and others can, without inventive effort, explore beyond the limits disclosed to determine if the invention is realized beyond those limits and, when embodiments are found to be without any unexpected characteristics, those embodiments are within the meaning of the term about as used herein. It is not difficult for the artisan or others to determine whether such an embodiment is either as expected or, because of either a break in the continuity of results or one or more features that are significantly better than reported by the inventor, is surprising and thus an unobvious teaching leading to a further advance in the art.

### BRIEF DESCRIPTION OF THE DRAWING

FIG. 1 is a schematic diagram showing a typical manufacturing process for producing a wet laid, nonwoven glass fiber mat useful for making the mat of the invention.

### DETAILED DESCRIPTION

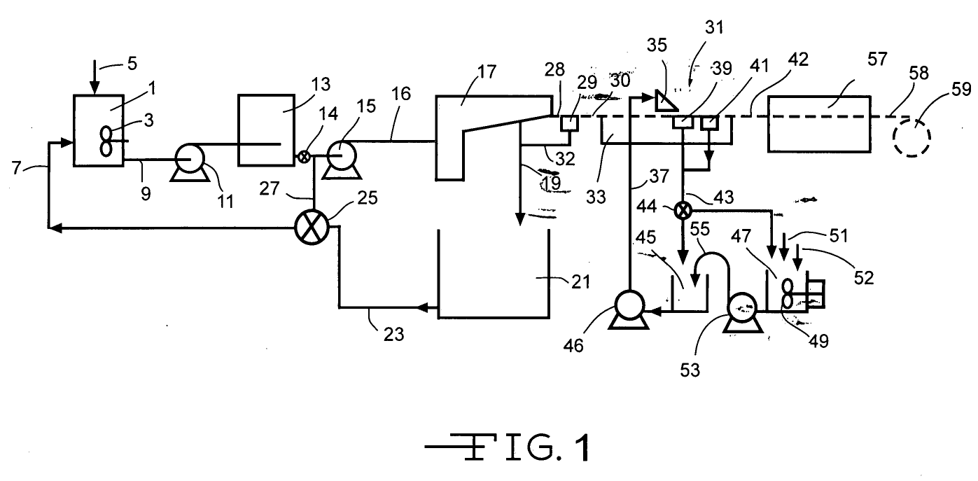

FIG. 1 is a schematic diagram of a preferred wet forming manufacturing process for producing the mats of the present invention. Fibers 5 are fed continuously at a controlled rate into a pulper 1 along with a conventional whitewater through a pipe 7, also continuously and at a controlled rate. An agitator 3 in the pulper 1 mixes and disperses the fibers in the whitewater. The resultant concentrated fibrous slurry flows continuously through a pipe 9 into an optional pump 11 that pumps the concentrated slurry into a fiber slurry holding tank 13. The concentrated fiber slurry is preferably metered continuously from the holding tank 11 with a valve 14 and into a metered flow of desired whitewater 27 to form a diluted fibrous slurry. The valve 25 meters a correct rate of desired whitewater to the pulper 1 via pipe 7 and a correct rate of desired whitewater 27 to form the diluted fiber slurry. The diluted fibrous slurry flows into the diluted fiber slurry. The diluted fibrous slurry flows into pump 15 and is pumped to the mat forming machine 17, which can be of any width and typically is wide enough to make a finished mat 12 feet wide or wider. Alternative forming methods include the known paper or board making processes such as cylinder forming.

The preferred processes for the production of mats of the present invention are those known processes using mat forming machines 17 like a Hydroformer™ manufactured by Voith-Sulzer of Appleton, WS, or a Deltaformer™ manufactured by North County Engineers of Glens Falls, N.Y. In these machines the diluted slurry flows generally horizontally against an inclined moving permeable belt or forming wire (not shown) where the fiber is collected, building up in a random pattern to the desired thickness to form a wet web 28 while the whitewater passes through the forming wire and is transported to a deairing tank 21, or in the alternative, a deairing holding pit (not shown), via pipe 19. The wet web is dewatered to the desired extent with one or more suction boxes 29, and a foamy whitewater removed thereby is piped through pipe 32 also to the deairing tank 21, preferably through the pipe 19.

This wet nonwoven web of fiber 30 is then preferably, but not necessarily, transferred to a second moving screen 33 and run through a binder application saturating station 31 where an aqueous binder is applied to the mat in any one of several known ways. Shown here, the aqueous binder is pumped at a controlled rate with pump 46 such that more binder slurry is pumped than is needed and this slurry is fed to a binder applicator, via pipe 37, where the binder slurry is applied in excess to the wet web 30.

The binder slurry is prepared by feeding an aqueous formaldehyde-free, heat resistant, binder 51, the binder comprising one or more resins or resin precursors, in an aqueous solution, emulsion or suspension, including a one-component epoxy, a two-component epoxy composition or two-component urethane binders, at a desired rate to a binder mix tank 47 having an agitator 49. The binder, as purchased is often more concentrated than desired, and can be diluted to the desired concentration by also metering water 52, into the mix tank 47 and mixing with the agitator 49 to form a homogenous binder mixture.

Any formaldehyde-free binder that provides a tensile strength in the dry mat of at least about 70 lbs./3 inch width at room temperature, with a loss-on-ignition in the mat (LOI) in the range of about 5 to about 30 wt. percent, more typically in the range of about 5 to about 22 wt. percent, and that provides sufficient hot strength to perform satisfactorily in a hot asphalt having a temperature of at least about 250 deg. F., more typically at least about 300 deg. F. and up to about 450 deg. F., coating process is suitable for the invention. The most used formaldehyde-free binders are a two-component epoxy resin system or urethane resin system, or a mixture of the epoxy resin and urethane resin. When these resins are used, it is important that the resin and the second component polymerizing initiator be intimately mixed in proper proportion, so that the fine particles of resin react to provide strong bonds between the glass fibers. The resin composition should be selected so that the binder does not undergo significant cross-linking and curing in the aqueous medium prior to the drying step in the mat making process. Epoxy compositions may include minor additions of urethane or acrylics in amounts up to about 20 wt. percent of an acrylic or urethane resin modifier or plasticizer. The urethane resin binders can also contain up to about 20 wt. percent of an acrylic resin modifier. Both the epoxy and the urethane based polymeric resins used in the invention have high temperature resistance, i.e. able to maintain a good bond between the fibers in the mat allowing the mat to withstand asphalt impregnation temperatures in the range of about 375 to 450° F. in asphalt shingle making processes.

One typical thermoset resin useful in the invention is an epoxy resin aqueous emulsion called EPIREZ™ 3510-W-60 available from Resolution Performance Products LLC Corp. of Houston, Tex. Other similar aqueous epoxy resins are also suitable in the invention. Some suitable aqueous urethane products include the SanCure™ family of waterborne urethane resins including 815 and 1601 products available from Noveon or Cleveland, Ohio. The higher softening point products are particularly useful in the invention.

The binder can also be a polyacrylic acid resin modified with up to about 20 wt. percent of an epoxy resin and/or a urethane resin to increase the heat resistance of the polyacrylic acid resin. Any formaldehyde-free binder that provides a tensile strength in the dry mat of at least about 70 lbs./3 inch width at room temperature, when having an LOI in the range of about 5 to about 30 wt. percent and that provides sufficient hot strength to perform satisfactorily in a hot molten material, like asphalt (up to about 450 deg. F.) coating process is suitable for the invention. The polyacrylic acid resin is a homopolymer or copolymer of polyacrylic acid. Preferably, the average molecular weight of the polyacrylic acid polymer is less than 10,000, more preferably less than 5,000, and most preferably about 3,000 or less, with about 2000 being preferred. Use of a low molecular weight polyacrylic acid polymer in a low-pH binder composition can result in a final product that exhibits excellent structural recovery and rigidity characteristics. The binder composition can also include at least one additional polycarboxy polymer such as, for example, a polycarboxy polymer disclosed in U.S. Pat. No. 6,331,350, the entire contents of which are incorporated by reference herein.

This binder mixture or slurry is then pumped to a binder holding tank 45 with a metering pump 53 and pipe 55 to maintain a desired level in the holding tank 45. A metering pump 46, controlled by the speed of the forming wire, pumps the binder slurry at the appropriate rate to the binder applicator 35. Shown here is a conventional curtain coater applicator, but many different types of applicators can be used instead as is well known. The binder slurry flows onto the wet web of fibers at the pumped rate and flows through the wet web of fibers coating at least some portions of the fibers, particularly at the points where the fibers contact one or more other fibers. Most of the excess binder slurry flows into a first suction box 39 and flows back into the binder holding tank 45 or the binder mix tank 47 via pipes and a valve 44. Usually more binder slurry remains in the wet web than is desired and this excess binder slurry is removed by pulling air through the wet, bindered web with a second suction box 41. The excess binder slurry removed flows back.

The wet, bindered web of the invention is then transferred continuously to a dryer belt 42 and carried through an oven 57 to dry the web and cure the binder, forming a dry mat 58 that is usually wound into a roll 59, in a known manner, for storage, shipment, or use on a roofing manufacturing machine or other mat processing machine. Heating and drying of the web of fibers and curing of the binder to form the mats of the invention is preferably accomplished by moving hot air through the mat in a known manner, but other known ways of heating the wet, bindered web of fibers is also suitable.

Any type of glass fibers can be used in the present invention. Normally, bundles of glass fibers chopped to a desirable length from about ⅛ inch to about 3 inches and preferably from about ¼ inch long to about 1.5 inches long are available from several suppliers for use in wet forming operations. Fibers from about ¾ inch long to about 1.5 inches long are most commonly used for roofing mats. These fibers are normally coated with a chemical sizing composition that varies from supplier to supplier and from product to product and are normally tailored to a specific customer or whitewater system or to a kind of wet forming machine. The present invention is suitable to all types of glass fibers including unsized fibers. When stated herein that the binder or resultant resin bond is in direct contact with the fiber(s), it is meant that the formaldehyde free resin bond is in direct contact with the bare fiber, or the bare fiber size coating without a coating of another resin intermediate. This excludes a mat bound with a formaldehyde or thermoplastic resin later overcoated, or impregnated with a formaldehyde free epoxy or urethane resin.

The mats of the present invention are useful in making products containing asphalt. These products are made in manufacturing processes in which the fiberglass mat is coated or saturated with hot, molten asphalt or a mixture containing hot, molten asphalt, to make roofing shingles, built-up roofing products, modified bitumen membranes or walking boards or other products. All of these processes subject the mat to temperatures ranging from 375-450° F. and higher, and to substantial tension at machine speeds ranging from 200-1500 ft./min. or higher. Conventional UF or MF bonded fiberglass mats can tolerate these harsh processing conditions due to the heat resistance of the thermoset bond, but binder systems that are based on formaldehyde-free acrylic systems do not have sufficient high temperature and fail due to stretching or breaking. The glass fiber mats of the invention sustain their structure during the hot asphalt impregnation process, withstanding temperatures up to 450° F. or higher. Tensile strength and tear resistance properties are also improved, or maintained with a lower binder content than conventional UF or MF bonded fiber glass mats. Lower binder contents, lower LOI (loss on ignition) is important to any product in which fire resistance is important, such as roofing products and other building products.

The binders used in the invention are in the form of fine particles dispersed in water, latexes, or aqueous solutions and are deposited upon the fibers in an aqueous mixture. The formaldehyde-free binder system for the aqueous laid glass fiber may be comprised of aqueous dispersible epoxies solely, or in combination with acrylics, urethanes, and/or polyamides. In each case, there results a one-part resin system that cures to create a bond. Alternatively, two part epoxies or two part urethanes may be used as a dispersion binder provided the resin and the initiator are well mixed and that the resin does not harden at temperatures typical in the wet sections of the wet forming and binder application zones of the forming machines.

Advantageously, an aqueous dispersion of epoxy resin is used. The fiberglass mats may also be bonded using a two-part urethane resin binder composition. The epoxy resin may be a one-part epoxy or a two part epoxy system. In the two-part epoxy system, the resin and the initiator are intimately mixed and the cure temperature of the resin is selected to be well above that of the aqueous processing temperatures so that the two part resin does not harden or cure in the aqueous processing step. The epoxy resin may also include urethanes, acrylics and other modifiers in quantities up to about 20 wt. percent, preferably below 15 wt. percent and most preferably up to about 10 wt. percent. Through this system, fiberglass mats can be bonded with high performance epoxy resins delivered in water, but it also yields a fiberglass mat with high performance properties. Unlike fiberglass mats bonded by acrylic resins, mats of the invention manifest greater heat resistance and can have improved tensile and tear strength properties, while also providing improved water resistance.

The mats of the present invention can be coated with a hot, molten material, such as asphalt, having a temperature of at least about 300 degrees F. and usually at least about 350 degrees F. while under tension in a continuous process using any conventional technology for making shingles or other roofing products. The mats will maintain their integrity during this critical part of the process, not distorting or failing that would cause a breakout and substantial downtime, due to the heat resistant bond between the fibers.

Fiber glass mats of the invention are useful in many products for the building construction industry, as roofing shingles, commercial roofing sheets or roll roofing, carpet tiles and sound deadening products for land vehicles, such as automobiles, trucks and the like.

Having thus described the invention in some detail, it will be understood that such detail need not be strictly adhered to, but that modifications and further embodiments will be obvious to one skilled in the art, all falling within the scope of the invention as defined by the following claims.

1. A formaldehyde-free, nonwoven, fiberglass mat, comprised of glass fibers bound together with a cured, heat resistant, resin binder capable of resisting temperatures of at least about 300 degrees F., the heat resistant resin being in direct contact with the glass fibers, the mats having a tensile strength in the dry mat of at least about 70 lbs./3 inch width at room temperature.

2. The mat of claim 1 wherein the resin is capable of resisting temperatures up to at least about 350 degrees F.

3. The mat of claim 1 wherein a majority of said glass fibers have a length in the range of about ½ inch to about 3 inches.

4. The mat of claim 2 wherein a majority of said glass fibers have a length in the range of about ½ inch to about 3 inches.

5. The mat of claim 1 wherein the resin comprises an epoxy resin derived from an aqueous, epoxy binder.

6. The mat of claim 3 wherein the resin comprises an epoxy resin derived from an aqueous, epoxy binder.

7. The mat of claim 5 wherein the cured resin is derived from a two-component binder comprising an intimate mixture of epoxy resin and a curing initiator.

8. The mat of claim 6 wherein the resin is derived from a two-component binder comprising an intimate mixture of epoxy resin and a curing initiator.

9. The mat of claim 1 wherein said resin is a urethane.

10. The mat of claim 2 wherein said resin is a urethane.

11. The mat of claim 9 wherein the urethane is derived from a two-component binder comprising an intimate mixture of urethane resin and initiator.

12. The mat of claim 10 wherein the urethane is derived from a two-component binder comprising an intimate mixture of urethane resin and initiator.

13. The mat of claim 1 wherein the binder content of the mat is in the range of about 5 to about 30 wt. percent.

14. The mat of claim 1 wherein the binder content of the mat is in the range of about 5 to about 22 wt. percent.

15. The mat of claim 1 wherein the binder content of the mat is in the range of about 5 to less than 15 wt. percent.

16. The mat of claim 1 wherein the binder content of the mat is in the range of about 5 to about 30 wt. percent the resin contains a urethane or an acrylic modifier in amounts of less than about 20%.

16. The mat of claim 1 wherein the binder content of the mat is in the range of about 5 to about 22 wt. percent the resin contains a urethane or an acrylic modifier in amounts of less than about 20%.

17. The mat of claim 1 wherein the binder content of the mat is in the range of about 5 to less than 15 wt. percent the resin contains a urethane or an acrylic modifier in amounts of less than about 20%.

18. The mat of claim 1 wherein the resin is a homopolymer or copolymer of polyacrylic acid modified with enough epoxy or urethane resin to make the resin bond heat resistant.

19. The mat of claim 3 wherein the binder content of the mat is in the range of about 5 to about 30 wt. percent.

20. The mat of claim 3 wherein the binder content of the mat is in the range of about 5 to about 22 wt. percent.

21. The mat of claim 3 wherein the binder content of the mat is in the range of about 5 to less than 15 wt. percent.

22. The mat of claim 3 wherein the binder content of the mat is in the range of about 5 to about 30 wt. percent the resin contains a urethane or an acrylic modifier in amounts of less than about 20%.

23. The mat of claim 3 wherein the binder content of the mat is in the range of about 5 to about 22 wt. percent the resin contains a urethane or an acrylic modifier in amounts of less than about 20%.

24. The mat of claim 3 wherein the binder content of the mat is in the range of about 5 to less than 15 wt. percent the resin contains a urethane or an acrylic modifier in amounts of less than about 20%.

25. The mat of claim 3 wherein the resin is a homopolymer or copolymer of polyacrylic acid modified with enough epoxy or urethane resin to make the resin bond heat resistant.

26. A method of making a formaldehyde free nonwoven mat comprising the steps of:
a) forming a wet web of fibers flowing an aqueous slurry containing fibers onto a moving permeable belt,
b) applying an aqueous binder onto the wet web of fibers, the binder containing a thermosetting, heat resistant, resin or resin mixture containing a heat resistant, thermosetting resin that when dried and cured to produce a mat having a binder content in the range of about 5 to 30 wt. percent, forms a bond between the fibers capable of resisting temperatures of at least about 300 degrees F., the heat resistant resin being in direct contact with the glass fibers,
c) drying the web and curing the binder to form a dry, nonwoven mat having a tensile strength of at least about 70 lbs./3 inch width at room temperature and capable of maintaining its integrity when coated with hot asphalt at a temperature of at least about 300 degrees F.

22. The method of claim 21 wherein the aqueous binder contains a resin selected from the group consisting of epoxy resin and urethane resin and mixtures thereof.

23. The method of claim 21 wherein the aqueous binder contains a homopolymer or copolymer of polyacrylic acid.

23. The method of claim 21 wherein the aqueous binder is applied in such a way to produce a loss on ignition of the dry mat of between about 5 and about 22 wt. percent.

24. An asphalt coated formaldehyde-free, nonwoven, fiberglass mat, comprised of glass fibers bound together with a cured, heat resistant, resin capable of resisting temperatures of at least about 300 degrees F., the heat resistant resin being in direct contact with the glass fibers, the mats having a tensile strength in the dry mat of at least about 70 lbs./3 inch width at room temperature and a binder content prior to being coated in the range of about 5 to 30 wt. percent, based on the weight of the dry uncoated mat.

25. The coated mats of claim 24 wherein a majority of said glass fibers have a length in the range of about ½ inch to about 3 inches.

28. The coated mats of claim 24 wherein the resin is selected from a group consisting of an epoxy resin, a urethane resin, a modified epoxy resin, a modified urethane resin, and a homopolymer or copolymer of polyacrylic acid modified with an epoxy resin or a urethane resin, all derived from an aqueous, binder.
